(19) United States
(12) Patent Application Publication
(10) Pub. No.: US 2004/0129071 A1
(43) Pub. Date: Jul. 8, 2004

(54) Thermal Finder

(76) Inventor: Jerzy Plaszowiecki, Stateline, NV (US)

Correspondence Address: JERZY PLASZOWIECKI, P.O. BOX 2799, MINDEN, NV, 89423, US

(21) Appl. No.: 10/248,315

(22) Filed: Jan. 8, 2003

(51) Int. Cl. G01W 1/00; G01P 13/00

(52) U.S. Cl. 73/170.16

(57) ABSTRACT

An object of the present invention is to provide a system helping glider pilots locate thermals in the air by constructing a database of places on the ground that are likely to generate thermals, and then, given the current weather conditions, showing the projected position of thermals in the air on a graphical display in the cockpit of the flying aircraft. The present invention achieves its objects by utilizing the two following methods: 1. Analyzing past flights from a given geographical area, extracting from them weather conditions during the flight, and places on the ground that have generated thermals in these weather conditions. 2. Analyzing the shape of terrain above which the flight is taking place to find places on the ground that receive the biggest amount of solar energy and wind energy, and therefore are most likely to generate thermals.

### BACKGROUND OF INVENTION

One of the objectives for the successful soaring of sailplanes, gliders or other un-powered aircraft is to remain aloft for an extended period of time by locating and navigating within upward flows of air called thermals. Generally, thermal updrafts are the most commonly used sources of lift for such aircraft although they are difficult to locate. The present invention describes a system to help locate thermals.

### DETAILED DESCRIPTION

Two methods are used to provide a system helping glider pilots to locate thermals in the air. Both methods result in creating a list of places on the ground that are likely to generate thermals. Positions of thermals from said list are then presented to the pilot in flight on a graphical display along with a map of terrain, so that the pilot can alter his or her course to maximize the probability of finding a thermal.

Method 1: Analyzing past flights from a given geographical area

Today most gliders fly with a device called flight data recorder that stores many flight parameters like position, speed, altitude, etc in a file called flight log, that after the flight can be retrieved and analyzed.

The present invention describes a method of aiding the pilot in locating updrafts (thermals) in a given area based on analyzing flight logs from that area.

A set of flight data logs from past flights performed over a given area is analyzed, and a list of places on the ground that have generated thermals found in flight logs is produced. Said list can then be used in subsequent flights, to aid the pilot in locating thermals generated by the same ground sources.

The following is a description of method to find places on the ground that generate thermals:

Each flight log is analyzed to compute wind speed and direction during the flight

The flight log is then analyzed again to find locations in the air where glider was using thermals.

It is not sufficient to store thermal positions that the glider was using in the air as a reference for future flights, because of the impact of wind. Thermals are generated by places on the ground, and if during a future flight the wind speed and direction is different than that found in a particular flight log, the thermal generated by the same ground source will be located in a different position in the air due to the wind pushing the column of raising air along with it. Therefore, a place on the ground that is likely to have generated a given thermal must be found. This is done by offsetting the location in the air where the glider started circling by the amount of air drift caused by the wind. This drift is directly proportional to wind speed, and altitude above ground of the place where the thermal was found, and inversely proportional to the thermal strength. The stronger the wind, and the higher above the ground the glider has contacted the thermal, the further away horizontally is the ground source that produced that thermal. Given the altitude above ground, climb rate of the thermal, and wind speed and direction at the time the thermal was found, a place on the ground is computed that has generated the given thermal.

Along with each thermal source, also other data related to a given thermal is stored for future use. That data includes Sun's azimuth and elevation (computed based on gps time and position), so that when the data is used in subsequent flights, only thermal sources active for that particular Sun position can be selected.

Another piece of information that needs to be stored with each thermal is the thermal's strength relative to other thermals on a given day. This information is later used in predicting the strength of thermal generated by ground source given the maximum thermal strength on a given day. Depending on the day, the maximum strength of thermals can differ significantly. Therefore, if during a flight log analysis it is found that the maximum thermal strength on a given day is for example 6 m/s, and the strength of a particular thermal is 3 m/s, it should be noted in the thermal database that this particular ground source generates thermals of strength 50% smaller than the day's maximum thermal strength.

Data from several flights can be merged into a list of thermal sources for a given area in to a thermal database for a given area. Such a database can then be taken on board of an aircraft, and used to aid finding thermals. To use the thermal database in flight, a projected location of the thermal that is rising from a given ground source must be found. If there is no wind during a flight, the thermal location in the air will be the same as the location of the ground source that has generated it. If there is wind present, the thermal location will be offset from the ground position of the place that has generated the thermal by the amount of the wind drift of the thermal.

Method 2: Analyzing the shape of terrain above which the flight is taking place to find places on the ground that receive the biggest amount of solar energy and wind energy.

With the arrival of Digital Elevation Models of the entire Earth, it is now possible to analyze terrain at any location that a glider flight takes place. This section describes a method of analyzing terrain to extract data locations on the ground most likely to generate thermals.

To predict which sections of terrain are most likely to generate thermals, two variables are computed for each section:

a) light angle

b) wind angle

Light angle describes what is the position of a given section of terrain in relation to Sun rays that are shining on it. The closer this angle is to 90 degrees, the more Sun energy does a given section receive, and the higher is the probability of this section generating a thermal.

Wind angle describes how is a given terrain section positioned in relation to the wind that is blowing over the terrain. For example, a wind blowing over a flat terrain does not generate an updraft by itself, but a wind blowing over a hill does. However, terrain sloping up at to high an angle causes more turbulence that updraft, so the maximum wind-induced lift is generated when the angle between wind and terrain surface is around 45 degrees.

Additional factor in predicting which spots are likely to generate wind induced thermals is the presence of valleys parallel to the wind. Usually good thermals are found at the end of a valley, when the wind is blowing towards that end.

After computing light angle and wind angle for all sections of terrain, influence of wind and light is combined, and places that have the highest probability of generating a thermal are added to the database of thermals, which is then shown on a graphical display to the pilot.

It is claimed:

1. A thermal finder for gliders and low power-to-weight aircraft, based on analyzing data from previous flights over a given area, and analyzing shape of terrain above which the flight is taking place.

2. The thermal finder of claim 1 wherein the predicted location of thermals is superimposed on top of a moving terrain map, to visually show the pilot where to steer the aircraft to find thermals.
